(19) United States
(12) Patent Application Publication
(10) Pub. No.: US 2002/0087619 A1
(43) Pub. Date: Jul. 4, 2002

(54) Method and sysem for server management platform instrumentation

(76) Inventor: Sharad C. Tripathi, Portland, OR (US)

Correspondence Address: PILLSBURY WINTHROP, LLP, P.O. BOX 10500, MCLEAN, VA, 22102, US

(21) Appl. No.: 09/749,635

(22) Filed: Dec. 28, 2000

(51) Int. Cl. G06F 15/16

(52) U.S. Cl. 709/202; 709/206

(57) ABSTRACT

A method and system for managing a server using remote intelligent mail messages is presented. An electronic mail message sent by a user is received by a mail agent. The message requests a service relevant to a server. The e-mail message is deciphered to understand the nature of the service requested by the user. If the user has the required access privilege, then the mail agent performs the service to produce a service outcome.

### BACKGROUND OF THE INVENTION

1. Field of the Invention

This invention relates in general to network server management. Specifically, this invention relates to methods and systems for remotely managing a network server.

2. General Background and Related Art

Computer systems are often managed by monitoring system health information, which reflects the operational status of various hardware components such as a processor and memory. The health information of a server may be made available through various sensors embedded in the motherboard of the server.

Server management products currently allow system administrators to observe health information through a console. In addition, system administrators can use the console to take various preemptive actions in response to particular health information. Such actions may include shutting down, rebooting, and powering off a server. Some products also send electronic mail messages to system administrators at predefined destinations in response to certain health conditions of a server.

Such messages merely inform an administrator of the server's health status. Upon receiving an e-mail message reporting a severe problem within a server, an administrator may have to physically go to the location of the server management management console in order to take preemptive action. When an administrator is far away from the console, such as at a remote site, it is often impossible for the administrator to take any action to protect the server.

Therefore, what is needed is a method and system that enables system administrators to take action remotely based on the health status of a server.

### BRIEF DESCRIPTION OF THE DRAWINGS

FIG. 1 is a block diagram illustrating a system according to an embodiment of the present invention.

FIG. 2 is a block diagram illustrating a mail agent according to an embodiment of the present invention.

FIG. 3 is a block diagram illustrating a system according to an embodiment of the present invention.

FIG. 4 is a flow diagram illustrating a method according to an embodiment of the present invention.

FIG. 5 is a flow diagram illustrating a method according to an embodiment of the present invention.

### DETAILED DESCRIPTION

The following detailed description refers to the accompanying drawings that illustrate exemplary embodiments of the present inventions. Other embodiments are possible and modifications may be made to the embodiments without departing from the spirit and scope of the invention. Therefore, the following detailed description is possible and modifications may be made to the embodiments without departing from the spirit and scope of the invention. Therefore, the following detailed description is not meant to limit the invention. Rather, the scope of the invention is defined by the appended claims.

It will be apparent to one of ordinary skill in the art that the embodiments as described below may be implemented in many different embodiments of software, firmware, and hardware in the entities illustrated in the figures. The actual software code or specialized control hardware used to implement the present invention is not limiting of the present invention. Thus, the operation and behavior of the embodiments will be described without specific reference to the actual software code or specialized hardware components. The absence of such specific references is feasible because it is clearly understood that artisans of ordinary skill would be able to design software and control hardware to implement the embodiments of the present invention based on the description herein with only a reasonable effort and without undue experimentation.

Moreover, the processes associated with the presented embodiments may be stored in any storage device, such as, for example, a computer system (non-volatile) memory, an optical disk, magnetic tape, or magnetic disk. Furthermore, the processes may be programmed when the computer system is manufactured or via a computer-readable medium at a later date. Such a medium may include any of the forms listed above with respect to storage devices and may further include, for example, a carrier wave modulated, or otherwise manipulated, to convey instructions that can be read, demodulated/decoded and executed by a computer.

A system and method for managing a server using remote intelligent mail messages, as described herein, involves receiving, by a mail agent, an electronic mail message sent by a user. The message requests a service relevant to a server. The message is deciphered to understand the nature of the service requested by the user. If it is determined that the user has a privilege to obtain the service, then the mail agent performs the service to produce a service outcome.

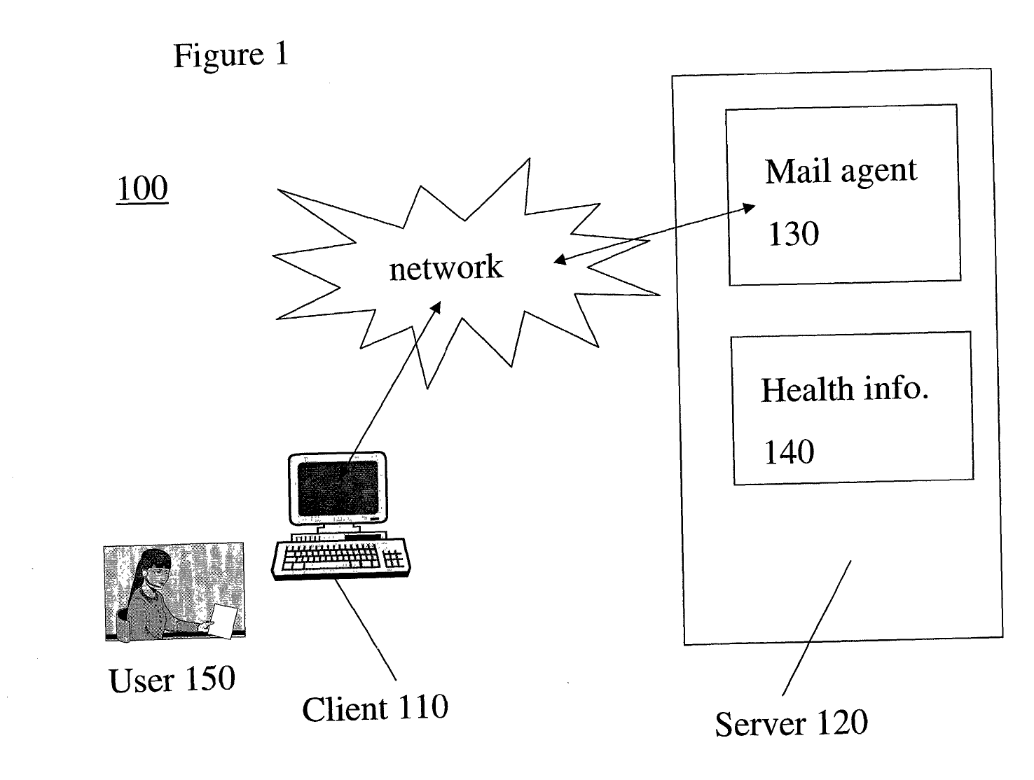

FIG. 1 is a block diagram illustrating system 100 according to an embodiment of the present invention. System 100 comprises client 110 and server 120. Server 120 comprises mail agent 130 and health information 140.

Client 110 communicates with mail agent 130 via a network connection, such as a wireless Internet or intranet connection. Alternatively, client 110 may communicate with mail agent 130 via a local area network (LAN) connection with cabling. Client 110 may comprise, for example, a remote computer at an airport, a cellular phone, or a wireless handheld device. Client 110 enables a user 150 to send an e-mail message to mail agent 130, and to receive an e-mail message from mail agent 130. A network administrator or other such user 150 may wish to send and receive messages using client 110 in order to access functions performed by mail agent 130.

Server 120 is configured to make health information 140 available. Health information 140 may include health of various hardware components of server 120, including processor, memory, fans, etc. Such health information 140 may be made available via various sensors that may be embedded in a motherboard of server 120. Based on the provided health information 140, user 150 may take preemptive actions, such as to shut down the server, reboot the server, and power off the server. In short, via e-mail, a network administrator may have access to complete server status information, manipulate the state of server 120, and take remedial actions.

Mail agent 130 may run on server 120. Mail agent 130 may receive an e-mail message sent by user 150. The e-mail message may request a service relevant to server 120. Mail agent 130 may decipher the e-mail message to understand the nature of the service requested by user 150. If mail agent 130 determines that user 150 has the privilege required to obtain the service, mail agent 130 may perform the service to produce a service outcome. E-mail messages sent by user 150 and mail agent 130 may be encrypted by client 110 and mail agent 130, respectively.

User 150 may belong to a set of categories, such as those embodied in an access control list (ACL). An ACL may divide users in a network comprising server 120 into multiple categories, including administrators who may have complete access to all information and functions available on server 120, and general users who may only view information within server 120. User 150 may send an e-mail message to mail agent 130 from client 110. However, user 150 may also send an e-mail message from a console (not shown) on server 120 itself.

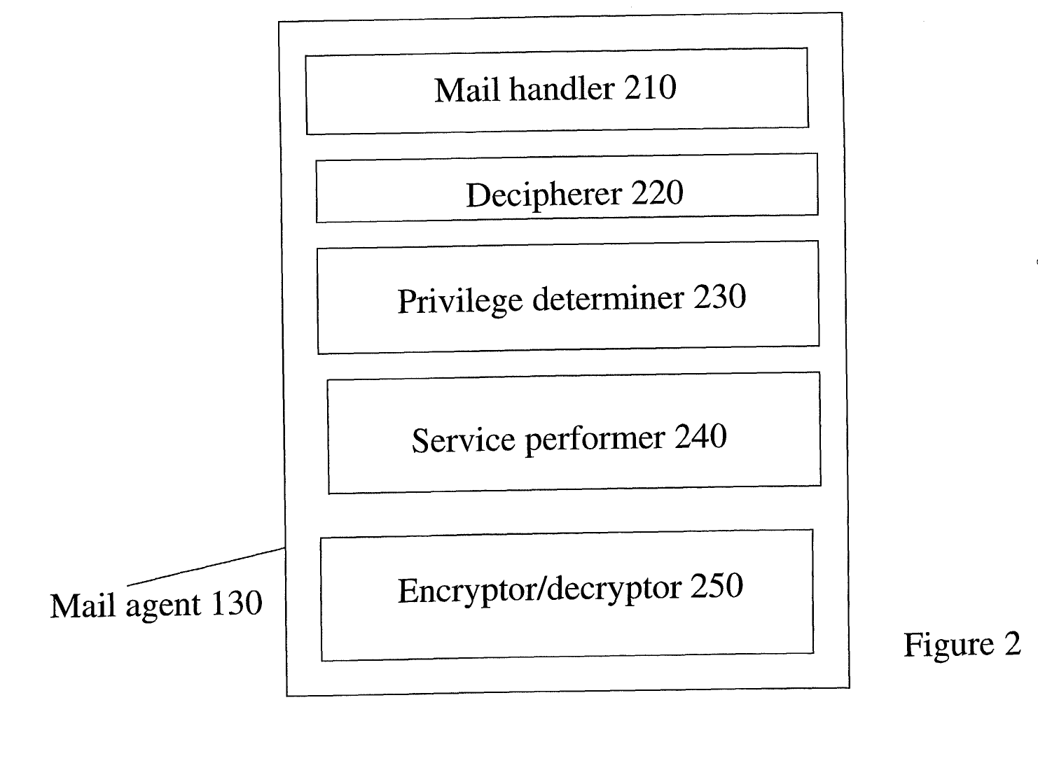

FIG. 2 is a block diagram illustrating mail agent 130 according to an embodiment of the present invention. As shown, mail agent 130 may comprise mail handler 210, decipherer 220, privilege determiner 230, service performer 240, and encryptor/decryptor 250.

Mail handler 210 may receive an e-mail message sent by user 150. Mail handler 210 may constantly run on server 320. Thus, mail handler 210 may receive e-mail messages sent by user 150 from client 310 or another such client at any time. Decipherer 220 deciphers such an e-mail message to ascertain the nature of the service, if any, requested by user 150. Such deciphering may include parsing the e-mail message to extract specific commands issued by user 150.

In an exemplary embodiment, preformatted messages may be used to exchange messages and information between client 310 and mail agent 130. Preformatted messages may include commands to execute actions, commands to enumerate status information, and commands to set various parameters, such as thresholds for different sensors embedded in a motherboard of a server Privilege determiner 230 determines whether user 150 is authorized to obtain a service that user 150 has requested. As such, privilege determiner 230 may first examine security credentials embodied in the e-mail message or associated with the sender of the message, authenticate the user, and verify that the user has the requisite access privilege. Privilege determiner 230 may consult an ACL that may be stored in server 320 or another such server. In view of information in the ACL, privilege determiner 230 may decide whether user 150 has the privilege required for the service.

Mail agent 130 may include encryptor/decryptor 250. Preformatted messages that may be exchanged between client 310 and mail agent 130 may be encrypted and decrypted at source and destination, respectively. Such a security measure may ensure that a security breach does not occur if an unauthorized person attempts to monitor transmissions between user 150 and mail agent 130, or if an unauthorized user attempts to issue service requests.

Service performer 240 may perform a service requested by an authorized user 150 to produce a service outcome. In an exemplary embodiment, service performer 240 may contact server 120, obtain health information from server 120, and generate a service outcome by composing a health information report based on the obtained health information.

A service requested by user 150 may include any service that may be performed by mail agent 130 and supported by the configuration of server 120. For instance, service performer 240 may inquire as to the health information associated with server 120, including memory usage, or take action on server 120, such as rebooting server 120.

Additionally, in other embodiments, service performer 240 may connect to a server to which the service pertains, execute an action on the server, determine the effect of the action on the server, and generate a service outcome based on the effect. Mail agent 130, via mail handler 210, may then generate a return e-mail message based on the service outcome, and send that message, in encrypted form, to user 150 as a reply to user 150.

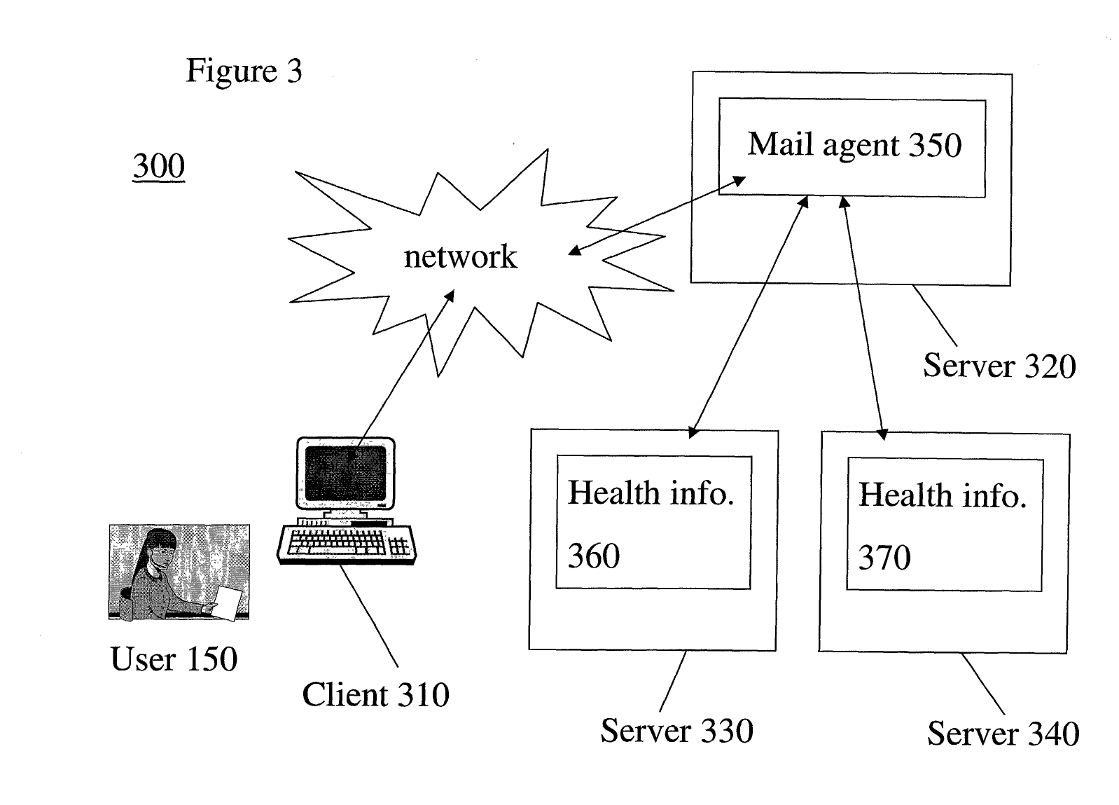

FIG. 3 is a block diagram illustrating system 300 according to another embodiment of the present invention. System 300 comprises client 310, server 320, server 330, and server 340. Mail agent 350 runs on server 320, but service outcomes are performed with respect to server 330 and server 340, which may include servers within a network including server 320. It is to be understood that a network may include multiple servers, such as server 330 and server 340, which may be accessible to mail agent 350.

In this embodiment, user 150 from client 310 may send an e-mail message to mail agent 350 requesting a service. The e-mail message may specify whether the service requested relates to a specific server, such as server 330, server 340, or another computer within a network, or whether the service is applicable to one or more specific servers within the network, or to all such servers. Mail agent 350, using mechanisms such as those described above, may decipher the e-mail message to ascertain the nature of the service requested by the user, and perform the service if user 150 has the requisite privilege to obtain that service. Mail agent 350 may produce a service outcome by performing the service.

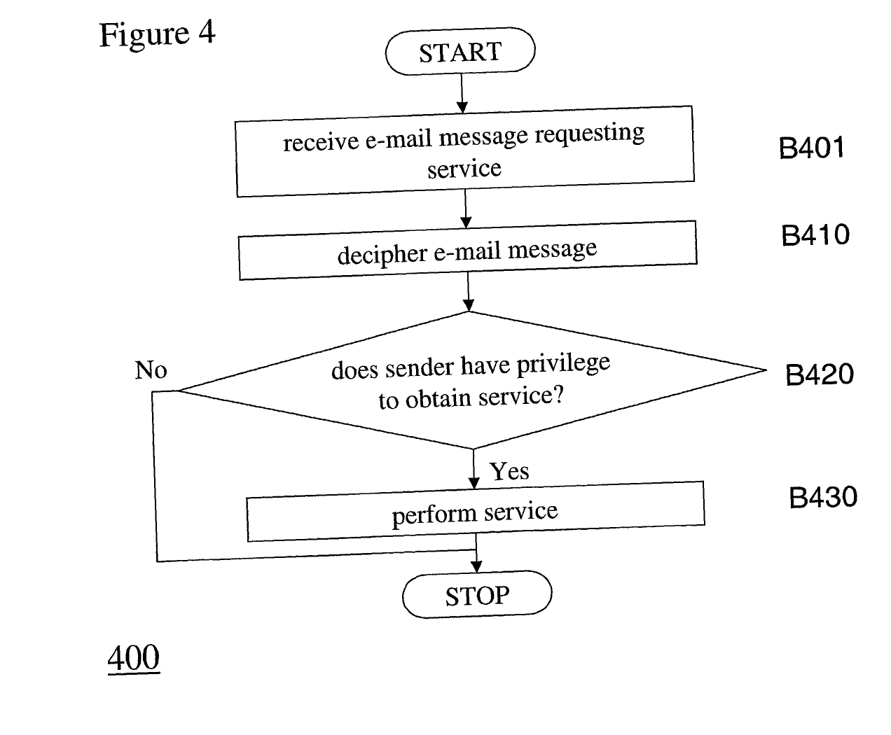

FIG. 4 is a flow diagram illustrating method 400 according to an embodiment of the present invention. In block B401, an e-mail message requesting a service is received by a mail agent. The e-mail message is deciphered in block B410. In block B420, the method inquires whether the sender of the e-mail message has a privilege to obtain the service requested. If the determination is no, then the method does not execute further. If the determination is yes, then in block B430, the service is performed, and the method ends.

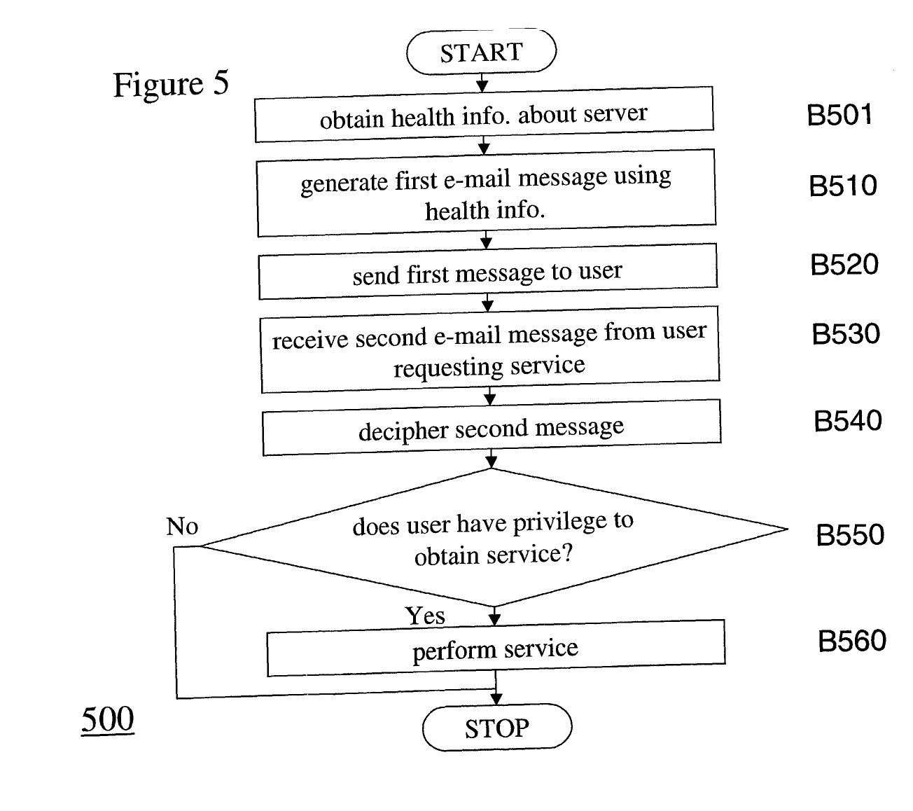

FIG. 5 illustrates method 500 according to another embodiment of the present invention. In block B501, health information about a server is obtained. In block B510, a mail agent may generate a first e-mail message using that health information. In block B520, the first message may be sent to a user. In block B530, the mail agent may receive a second e-mail message from the user which requests a particular service. The second message is deciphered in block B540. In block B550, the method determines whether the user has the requisite privilege to obtain the service. If the determination is no, then the method ceases. If the determination is yes, then in block B560, the service requested by the user is performed.

The foregoing description of the preferred embodiments is provided to enable any person skilled in the art to make or use the present invention. Various modifications to these embodiments are possible, and the generic principles presented herein may be applied to other embodiments as well. For instance, to maintain security, the system and method described above may include security at multiple levels, including domain registration, user ID/password registration, encryption/decryption, predefined command formats, and inclusion of authentication packets in command messages.

Moreover, the invention may be implemented in part or in whole as a hard-wired circuit, as a circuit configuration fabricated into an application-specific integrated circuit, or as a firmware program loaded into non-volatile storage or a software program loaded from or into a data storage medium as machine-readable code, such code being instructions executable by an array of logic elements such as a microprocessor or other digital signal processing unit.

As such, the present invention is not intended to be limited to the embodiments shown above but rather is to be accorded the widest scope consistent with the principles and novel features disclosed in any fashion herein.

What is claimed:

1. A method for managing at least one server using remote intelligent mail messages, the method comprising:
receiving, by a mail agent, an electronic mail message, sent by a user, requesting a service relevant to the at least one server;
deciphering the electronic mail message to understand the nature of the service requested by the user;
determining whether the user has a privilege to obtain the service; and
performing the service, by the mail agent, if the user has the privilege, to produce a service outcome.

2. The method according to claim 1, wherein the mail agent runs on one of the at least one server.

3. The method according to claim 1, wherein the electronic mail message includes an encrypted electronic mail message.

4. The method according to claim 1, wherein the user belongs to at least one category of a set of categories.

5. The method according to claim 4, wherein the at least one category includes a category of server administrators having a complete information access privilege.

6. The method according to claim 4, wherein the at least one category includes a category of users having an access privilege to view information only.

7. The method according to claim 1, wherein the user sends the electronic mail message from a client.

8. The method according to claim 7, wherein the client includes one of a remote computer, a cellular phone, and a wireless handheld device.

9. The method according to claim 1, wherein the deciphering comprises parsing the electronic mail message.

10. The method according to claim 9, further comprising decrypting the electronic mail message, if the electronic mail message is sent encrypted.

11. The method according to claim 1, wherein the determining comprises:
examining the security credentials of the electronic mail message;
authenticating the user;
verifying the access privilege of the user based on an access control list stored in the server; and
deciding whether the user has the privilege for the service based on results from the examining, the authenticating, and the verifying.

12. The method according to claim 1, wherein the service includes inquiring as to health information of the at least one server.

13. The method according to claim 12, wherein the health information includes memory usage.

14. The method according to claim 12, wherein the performing comprises:
contacting at least one server to which the service pertains;
obtaining the health information from each server that is contacted by the contacting; and
generating the service outcome by composing a health information report based on the health information obtained by the obtaining.

15. The method according to claim 1, wherein the service includes taking at least one action on the at least one server.

16. The method according to claim 15, wherein the action includes a reboot.

17. The method according to claim 15, wherein the performing comprises:
connecting to at least one server to which the service pertains;
executing the at least one action on the at least one server;
determining the effect of the at least one action on the at least one server; and
generating the service outcome based on the effect, determined by the determining.

18. The method according to claim 1, further comprising:
generating a return electronic mail message based on the service outcome; and
sending the return electronic mail message to the user as a reply to the requesting a service.

19. The method according to claim 18, further comprising encrypting the return electronic mail message prior to the sending.

20. A method for managing at least one server using remote intelligent mail messages, the method comprising:
obtaining, from at least one server health monitoring system, health information about at least one server;
generating a first electronic mail message using the health information;
sending, by a mail agent, the first electronic mail message to a user;
receiving, by the mail agent, a second electronic mail message, sent by the user, requesting a service relevant to the at least one server;
deciphering the second electronic mail message to understand the nature of the service requested by the user;
determining whether the user has a privilege to obtain the service; and
performing the service, by the mail agent, if the user has the privilege for the service.

21. The method of claim 20, wherein the first electronic mail message is generated by the mail agent.

22. A system for managing a server using remote intelligent mail messages, the system comprising:
a server;
a client configured to allow a user to send electronic mail; and
a mail agent configured to communicate with the server and the client, the mail agent being further configured to receive an electronic mail message, sent by the user from the client, requesting a service relevant to the server, decipher the electronic mail message to understand the nature of the service requested by the user, and perform the service to produce a service outcome.

23. The system of claim 22, wherein the mail agent runs on the server.

24. The system of claim 22, wherein the client includes one of a remote computer, a cellular phone, and a wireless handheld device.

25. A mail agent for managing at least one server using remote intelligent mail messages, the mail agent comprising:
a mail handler configured to receive an electronic mail message, sent by a user, requesting a service relevant to the at least one server;
a deciphering mechanism configured to decipher the electronic mail message to understand the nature of the service requested by the user;
a privilege determination mechanism configured to determine whether the user has a privilege to obtain the service; and
a service performance mechanism configured to perform the service, if the user has the privilege, to produce a service outcome.

26. The mail agent of claim 25, further comprising a decryption mechanism configured to decrypt the electronic mail message if the electronic mail message is sent encrypted.

27. A computer-readable medium encoded with a plurality of processor-executable instructions for:
receiving, by a mail agent, an electronic mail message, sent by a user, requesting a service relevant to the at least one server;
deciphering the electronic mail message to understand the nature of the service requested by the user;
determining whether the user has a privilege to obtain the service; and
performing the service, by the mail agent, if the user has the privilege, to produce a service outcome.

28. The computer-readable medium of claim 26, wherein the deciphering comprises parsing the electronic mail message.

29. A computer-readable medium encoded with a plurality of processor-executable instructions for:
obtaining, from at least one server health monitoring system, health information about at least one server;
generating a first electronic mail message using the health information;
sending, by a mail agent, the first electronic mail message to a user;
receiving, by the mail agent, a second electronic mail message, sent by the user, requesting a service relevant to the at least one server;
deciphering the second electronic mail message to understand the nature of the service requested by the user;
determining whether the user has a privilege to obtain the service; and
performing the service, by the mail agent, if the user has the privilege for the service.

30. The computer-readable medium of claim 29, wherein the first electronic mail message is generated by the mail agent.
